(19) United States
(12) Patent Application Publication
(10) Pub. No.: US 2026/0196906 A1
(43) Pub. Date: Jul. 9, 2026

(54) Electric motor

(71) Applicant: Donald Moses, St-Côme (CA)

(72) Inventor: Donald Moses, St-Côme (CA)

(21) Appl. No.: 19/014,094

(22) Filed: Jan. 8, 2025

(51) Int. Cl. H02K 11/33; H02K 3/18; H02K 3/28; H02K 11/00

(52) U.S. Cl. CPC H02K 11/33; H02K 3/18; H02K 3/28; H02K 11/0094

(57) ABSTRACT

An electric motor having three phase each powered by a respective power module including a capacitor, the electric motor, comprising a plurality of coils each activatable by selectively providing direct current thereto from a respective one of the power modules, wherein for each phase, the electric motor is configured to recover energy stored in at least one of the coils into the capacitor when the direct current is switched off.

### FIELD OF THE INVENTION

The present invention relates to the general field of motors, and is more particularly concerned with an electric motor.

### BACKGROUND

Powerful electric motors are often powered using alternating current, for example triphasic alternating current. In some applications, such as in electric and hybrid vehicles, this alternating current is provided by an inverter connected to batteries. There is some loss of power in the inverter. In addition, the need for an auxiliary glycol cooling pump is often used to successfully cool the inverter.

Also, in these motors, the polarity of coils powered by the alternating current changes as a function of the position of the motor's rotor. Therefore, during each rotation of the rotor, each coil is powered with a first polarity, which creates a magnetic field having a first orientation, followed by reversal of the polarity, and therefore of the magnetic field. To reverse the orientation of the magnetic field, the magnetic field must first be reduced to zero before being increased with the opposite orientation. The energy stored in the magnetic field must therefore be removed from the coil each time the orientation of the magnetic field is reversed. Part of this energy may be recovered in some motors, but there are many parasitic losses that decrease the efficiency of the motor. Thus, there is a need on the market for an improved electric motor. An object of the present invention is therefore to provides such an electric motor.

### SUMMARY OF THE INVENTION

In a broad aspect, there is provided an electric motor, comprising a rotor including a permanent magnet; a stator including coils disposed circumferentially therearound and operable in three phases; three power modules each operable for powering a respective phase selected from the three phases each power module including a pair of power input terminals for receiving direct current (DC) electrical power; a capacitor; and a plurality of switches selectively openable and closable so that the coils from the respective phase are each operable between a powered mode and a recovery mode, wherein, in the powered mode, the coils from the respective phase are electrically coupled to the power input terminals, the capacitor, or both the power input terminals and the capacitor to allow transfer of electric power from at least one of the power input terminals and the capacitor to the coils of the respective phase, and, in the recovery mode, the coils of the respective phase are electrically coupled to the capacitor to allow transfer of energy stored in the coils of the respective phase to the capacitor; wherein in operation, each of the three phases are operated alternatively between the powered mode and the recovery mode with an offset of 120 degrees between the phases.

It should be noted that a phase in the preceding paragraph refers to an electrical phase in operation of the motor. The term phase does not refer to a physical arrangement of the coils, but to an electrical circuit using selected ones of the coils. In some embodiments, some of coils are shared between different phases, as will be further detailed below.

There may also be provided an electric motor wherein, in the powered mode, the coils of the respective phase are electrically coupled to both the power input terminals and the capacitor in parallel.

There may also be provided an electric motor wherein each power module further comprises a diode for preventing discharge of the capacitor towards the power input terminals.

There may also be provided an electric motor wherein for each of the power modules, the pair of power input terminals is a first pair of power input terminals, the capacitor is a first capacitor, the powered mode is a first powered mode, and the recovery mode is a first recovery mode, the electric motor further comprising a second capacitor; the plurality of switches are selectively openable and closable so that the coils from the respective phase is operable between a second powered mode and a second recovery mode, wherein, in the second powered mode, the coils from the respective phase are electrically coupled to the power input terminal, the second capacitor, or both the power input terminal and the second capacitor to allow transfer of energy from at least one of the power input terminal and the second capacitor to the coil, and, in the second recovery mode, the coils from the respective phase are electrically coupled to the second capacitor to allow transfer of energy stored in the coils from the respective phase to the second capacitor; the first and second power modes operating the coils from the respective phase with inverse polarities relative to each other.

There may also be provided an electric motor wherein in the first and second recovery modes, the first and second capacitors and the coils from the respective phase are all in series with the first and second capacitors having anodes thereof connected to each other through a diode.

There may also be provided an electric motor wherein in the first and second recovery modes, transfer of energy from the coil to one of the first and second capacitors is facilitated by the other one of the first and second capacitors due to the voltage of the first and second capacitors being in series with the coil with inverted polarities.

There may also be provided an electric motor wherein the rotor defines a north pole and a south pole; each of the coils from the respective phase are electrically connected in series to another one of the coils from the respective phase located diametrically opposed thereto on the stator and wound such that forces exerted on the north and south poles by the two coils are similar to each other.

There may also be provided an electric motor wherein the coils include wye coils connected to each other in a wye configuration defining three branches each defining opposed proximal and distal ends, the proximal ends being substantially equipotentially electrically linked to each other, the remaining coils being distributed among three edges each defining edge first and second ends, two of the edge second ends and one of the distal ends being substantially equipotentially electrically linked to each other, and the remaining edge being substantially equipotentially electrically linked to an other one of the distal ends, wherein each of the three phases includes a respective pair of the branches and a respective one of the edges.

There may also be provided an electric motor wherein the edges have substantially similar edge inductances, and the branches have substantially similar branch inductances.

There may also be provided an electric motor wherein the edge inductances are about twice the branch inductances.

There may also be provided an electric motor wherein within each phase, the wye coils and the edge coils are electrically offset by about 30 degrees.

There may also be provided an electric motor wherein the coils within each side are angularly superposed with the coils of a respective one of the branches.

There may also be provided an electric motor further comprising a position sensor for sensing a relative position between the rotor and the stator.

There may also be provided an electric motor further comprising a speed sensor for sensing a relative rotation speed between the rotor and the stator.

There may also be provided an electric motor wherein the motor is operable to exert a braking action to recover mechanical energy from a moving mass connected to the motor by slowing down the moving mass and transferring energy to the power terminals.

There may also be provided an electric motor wherein the switches from the plurality of switches are electronic switches, the electric motor further comprising a controller for selectively individually opening and closing the electronic switches.

There may also be provided an electric motor further comprising a switching circuit for selectively connecting a single DC power source to the first and second power input terminals of a selected one of the power control module.

There may also be provided an electric motor further comprising diodes for preventing transfer of power from the capacitor towards the battery, whereby the energy recovered during operation in a recovery mode and stored in the capacitor is used to at least partially power a following powered mode.

There may also be provided an electric motor wherein the powered mode in each one the three phases overlaps with the recovery mode of the other two phases and the recovery mode in each one the three phases overlaps with the powered mode of the other two phases.

There may also be provided an electric motor wherein each phase in the powered mode includes at least one shared coil, the shared coil being part of another one of the phases operated in the recovery mode, the shared coil being configured such that the electromotive force (EMF) created by the recovery mode and the tension created by the powered mode have a same polarity.

There may also be provided an electric motor wherein in each one of the phases, a respective one of the edge is connected in series with a respective pair of the branches.

Advantageously, the proposed motor recovers in the capacitor at large portion of the energy stored in the magnetic field of the coils when their polarity is reversed, so that this energy can be used to power the coils in subsequent cycles. Also, the proposed motor does not require an inverter, and the associated inefficiencies. Furthermore, in some embodiments, the proposed motor can produce relatively large torques. This is due to the use of capacitors that can generate relatively high tensions, which result in large currents, and therefore large magnetic fields in the coils.

Since each phase of the electric motor is associated with a respective power module, each phase can be powered over a relatively large angular displacement of the rotor, and each recovery phase can also last for a relatively large angular displacement of the rotor. Indeed, each power/recovery cycle can last for up to 180 degrees of rotation of the rotor before the next power/recovery cycle starts, with an inverted polarity.

In addition, one of the branches that enters a recovery part of the power/recovery cycle of one of the phases will be part of the powered part of the power/recovery cycle of the next phase, with polarities such that the electromotive force due to the recovery in the first phase will add up to the electromotive force used to power the second phase, creating larger peak current in the power phase, and therefore larger torques in the electric motor.

Yet furthermore, each power module switches only four times between the recovery and power modes over a full turn of them motor, which requires a relatively small number of operations of each switch for each turn when compared to a similar motor having a single power module powering the three phases, which helps in preventing overheating of the switches.

Yet furthermore, when the electric motor does not need to provide large torques, only one or two of the power modules may be activated.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a schematic view, illustrates the electric circuit of an electric motor in accordance with an embodiment of the present invention;

FIG. 2, in a schematic view, illustrates the wiring of one configuration example of the electric motor of FIG. 1;

FIG. 3, in a schematic view, illustrates a timing diagram in a method of operation of the electric motor of FIG. 1;

FIG. 4, in a schematic view, illustrates a controller usable to control the electric motor of FIG. 1, along with components connected thereto; and

FIG. 5, in a schematic view, illustrates the electric circuit of power modules of an electric motor in accordance with an alternative embodiment of the present invention.

### DETAILED DESCRIPTION

The terms “substantially” and “about” are used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention.

Generally speaking, the proposed motor uses DC current to power coils using brief pulses of current and includes energy storage components, such as capacitors, to recover at least part of the energy stored in the magnetic field of the coils when the later are unpowered during some phases of the motor operation. This recovered energy can then be used to power the coils in subsequent phases of motor operation.

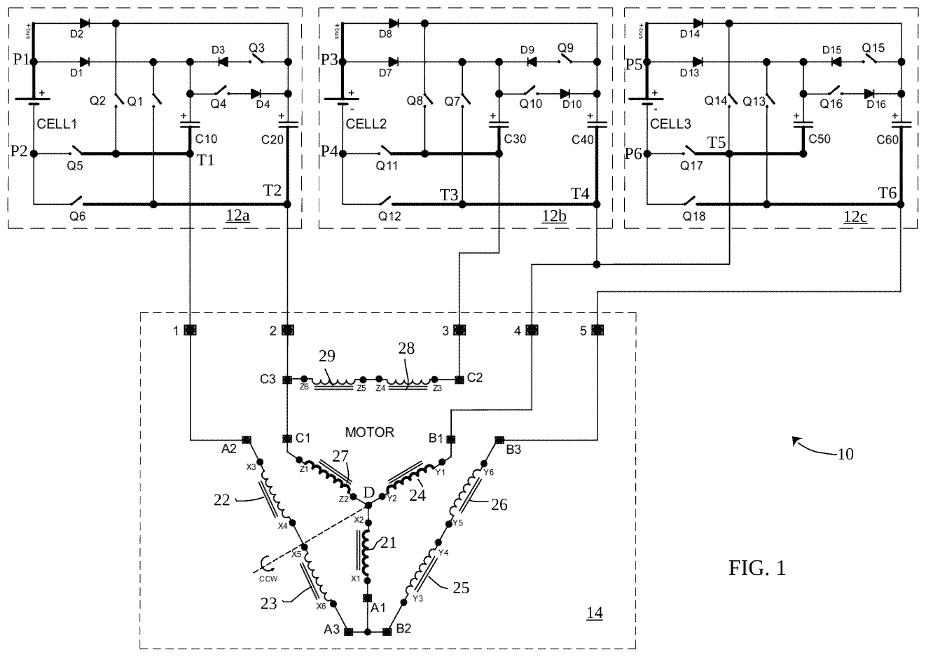

FIG. 1 illustrates schematically the electric circuit representing the proposed electric motor 10. The motor 10 includes three power modules 12a, 12b and 12c and a motor module 14. The power modules 12a, 12b and 12c include the various components required to selectively provide current to the motor module 14 and recover at least part of the magnetic energy stored in the motor module 14 when delivery of electrical power thereto is interrupted. The motor module 14 includes components that will be switched on and off during operation of the motor 10 to provide a motive force to a rotor, as further described below. The power modules 12a, 12b and 12c are each powered by a respective battery CELL1, CELL2 and CELL3, although a single battery or more than two batteries could be used in alternative embodiments to power each module. Also, as detailed below, the power modules 12a, 12b and 12c may share a common battery if suitable circuitry is added to the electric motor 10. The batteries CELL1, CELL2 and CELL3 include for example a plurality of lithium-ion cells, or any other types of battery cells usable to provide direct current. The motor module 14 is configured to have three phases, each of which is powered by a respective one of the power modules.

In the power module 12a, the battery CELL1 is connected at the cathode to a first power input terminal P1 and at the anode to a second power input terminal P2. While the battery CELL1 is shown as part of the power module 12 in FIG. 1, in some embodiments, the battery CELL1 is remote from the power module 12 and not part thereof. The power modules 12b and 12c are similar, with the battery CELL1 and the first and second power input terminals P1 and P2 being replaced respectively therein by the batteries CELL2 and CELL3 and the pairs of first and second power input terminals (P3 and P4) and (P5 and P6). The power module 12a also includes a pair of terminals T1 and T2 electrically connected to the motor module 14 as further described below. Similarly, the power module 12b includes terminals T3 and T4 and the power module 12c includes terminals T5 and T6, all also electrically connected to the motor module 14. Internal components of the power modules 12a, 12b and 12c control the flow of energy through the terminals T1 to T6, either allowing or preventing such flow.

The motor module 14 has five input nodes A2, B1, B3, C2 and C3. Selected pairs of the five input nodes A2, B1, B3, C2 and C3 are electrically connected to the power modules 12a, 12b and 12c. More specifically, terminals T1 and T2 of the power module 12a are connected respectively to the input nodes A2 and C3, terminals T3 and T4 of the power module 12b are connected respectively to the input nodes C2 and B1, and terminals T5 and T6 of the power module 12c are respectively connected to the input nodes B1 and B3.

The motor module 14 also has five internal nodes A1, A3, B2, C1 and D. Internal nodes A1, A3, B2, are electrically connected to each other to be at the same potential, and internal node C1 is similarly electrically connected to external node C3.

The motor module 14 also includes nine coil equivalents 21 to 29 extending between selected ones of the input and internal nodes A1 to D. A coil equivalent 21 to 29 includes one or more coils provided in series with each other and used to generate a magnetic field in the motor 10 to provide motive force. A coil equivalent 21 to 29 therefore behaves like an inductance with a relatively small resistance in the motor module 14. In a typical embodiment, the coils are part of the stator of a motor 10 and used to rotate a rotor including for example permanent magnets, as further described below. The coil equivalents 21 to 29 all have substantially similar inductance. This is convenient as similar coils can then be used in the physical implementation of the electric motor 10. However, some of the coil equivalents 21 to 29 that are in series to each other could be replaced by a single coil equivalent having a different inductance, as detailed below. Each coil equivalent 21 to 29 extends between two nodes according to the configuration set forth in Table 1.

TABLE 1
Position of the coil equivalents 21 to 29
relative to the nodes X1 to Z6 in FIG. 1

| Coil equivalent | First node | Second node |
|---|---|---|
| 21 | X1 | X2 |
| 22 | X3 | X4 |
| 23 | X5 | X6 |
| 24 | Y1 | Y2 |
| 25 | Y3 | Y4 |
| 26 | Y5 | Y6 |
| 27 | Z1 | Z2 |
| 28 | Z3 | Z4 |
| 29 | Z5 | Z6 |

To complete the description of the motor module 14, the following pairs of nodes are connected to each other to be substantially at the same potential: A2 and X3, X4 and X5, X6 and A3, X1 and A1, Z1 and C2, Y1 and B1, Z2 and D, Y2 and D, X2 and D, B2 and Y3, B3 and Y6, Y4 and Y5, C3 and Z6, C2 and Z3, and Z4 and Z5.

Coil equivalents 21, 24 and 27 are provided in a wye configuration. To that effect, nodes X2, Y2 and Z2 are all electrically connected to a central node D. Electrically connected nodes have substantially identical electrical potentials, with extremely minor potential drops due to the resistance of the wires interconnecting the nodes. Therefore, coil equivalents 21, 24 and 27 form branches of the wye configuration. Coil equivalents 22 and 23, 25 and 26, and 28 and 29 are pairwise connected in series and form 3 edges including respectively coil equivalents 22 and 23, coil equivalents 25 and 26, and coil equivalents 28 and 29.

The power module 12a includes two terminals T1 and T2, previously described, two capacitors C10 and C20, four diodes D1, D2, D3 and D4, and six switches Q1, Q2, Q3, Q4, Q5 and Q6. The reader skilled in the art will understand the exact number and configuration of these components may vary according to the exact embodiment of the invention without departing from the scope of the claims. The switches Q1 to Q6 are typically high speed electronic power switches allowing to rapidly switch between open and closed states and to carry in the closed state relatively large currents. The capacitors C10 and C20 could be individual physical capacitors, or banks of such physical capacitors, or supercapacitors. The capacitors C10 and C20 can be charged and discharged relatively rapidly under relatively large tensions to receive and release electric energy in the form of charges stored on metal components separated from each other by a dielectric material. This is to be contrasted to batteries, which use electrochemical reactions to store energy. The diodes D1 to D4 are used to only allow unidirectional flow of current between some components, as described below.

Terminals T1 and T2 are electrically connected respectively to the cathode of capacitors C10 and C20. Diodes D1 and D2 extend respectively between the first and second power terminals P1 and P2 and the anode of capacitors C10 and C20 and are oriented to prevent current to to flow back to the battery CELL1 from the capacitors C10 and C20.

The anodes of the two capacitors C10 and C20 are interconnected by diodes D3 and D4 in parallel and oriented in opposite direction, so that current flows through diode D3 from capacitor C20 to capacitor C10, current flows through diode D4 from capacitor C10 to capacitor C20. These current flows between the capacitors are controlled by switches Q3 and Q4 both in series with a respective diode D3 and D4. Therefore, current cannot flow between the anodes of the capacitors C10 and C20 unless at least one of the switches Q3 or Q4 is closed.

The cathode of capacitors C10 and C20 are connected to the power input terminal P2, which is connected to the anode of the battery CELL1, with respectively switches Q5 and Q6 extending therebetween. Switches Q1 and Q2 extend respectively between the terminals T2 and T1 and the diode D1 or D2 extending from the power input terminal P1, which is connected to the cathode of the battery.

The structure of the power modules 12b and 12c is similar, with the correspondence between the components of the power modules 12a, 12b and 12c given by the following triplets, corresponding in order to the components of power modules 12a, 12b and 12c: (P1, P3, P5), (P2, P4, P6), (T1, T3, T5), (T2, T4, T6), (Q1, Q7, Q13), (Q2, Q8, Q14), (Q3, Q9, Q15), (Q4, Q10, Q16), (Q5, Q11, Q17), (Q6, Q12, Q18), (D1, D7, D13), (D2, D8, D14), (D3, D9, D15), (D4, D10, D16), (C10, C30, C50) and (C20, C40, C60).

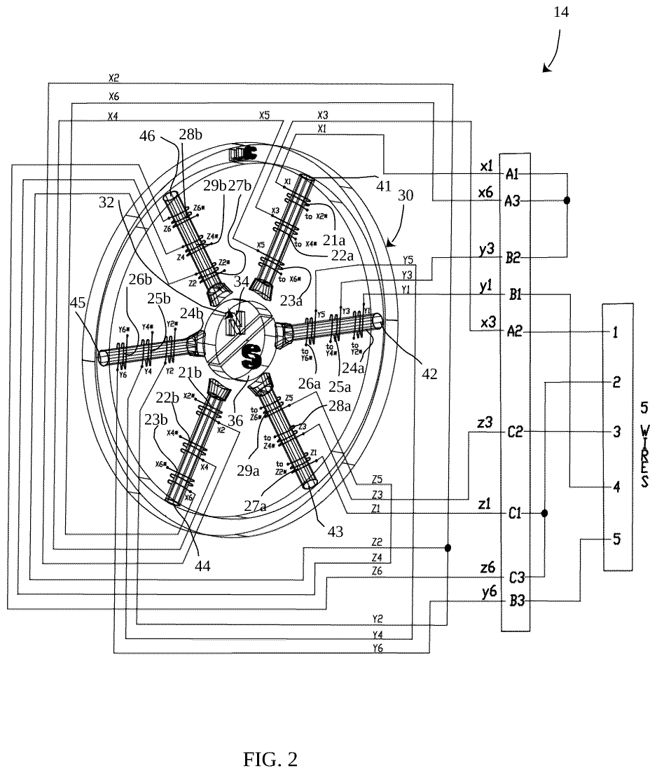

FIG. 2 illustrates the physical configuration of the power module 14. The power module 14 includes a stator 30 and a rotor 32. The rotor 32 is mounted so as to be rotatable about the stator 30, and typically includes an output shaft (not shown in the drawings) to provide rotational power from rotation of the rotor 32. The rotor 32 shown in the drawings is bipolar and includes one or more permanent magnets defining opposed north and south poles 34 and 36. However, in alternative embodiments, the rotor 32 includes more than two poles. Also, the rotor 32 may include electromagnets or superconducting electromagnets.

The stator 30 includes 6 poles 41 to 46 forming 3 pole pairs. Poles 41 and 44 are paired, poles 42 and 45 are paired, and poles 43 and 46 are paired. The poles 41 to 46 within each pair are diametrically opposed, and the pairs are physically 60 degrees out of phase relative to to each other on the stator 30. The coils 21a to 29b of each pole 41 to 46 produce magnetic fields of opposite polarity relative to the coils 21a to 29b located on their paired pole 41 to 46, as the rotor 32 is bipolar. Each pole pair corresponds to three coil equivalents 21 to 29. Each coil equivalent 21 to 29 includes respectively two coils 21a and 21b to 29a to 29b, located on opposite poles 41 to 46. Coil equivalents 21, 22 and 23 are wound on pole 41 and 44, coil equivalents 24, 25 and 26 are wound on poles 42 and 45, and coil equivalent 27, 28 and 29 are wound on poles 43 and 46. While the coils 21a to 29b shown in FIG. 2 are shown spaced apart from each other, the coils 21a to 29b are typically intertwined or wound adjacent or on top of each other, such that the coils 21a to 29b provided at each pole 41 to 46 provides a similar magnetic attraction to the rotor 32.

A specific example of correspondence between FIGS. 1 and 2 is now given, with the understanding that similar relationships exist for the other coils 21a to 29b and coil equivalents 21 to 29. Coil equivalent 21 includes coils 21a and 21b. Coils 21a starts at node X1 and ends at node “to X2*”, which is connected to node X2* through a wire, not shown in FIG. 2 for clarity reason. Coil 21b starts at node X2* and finishes at node X2. Coils 21a and 21b are therefore in series, and are wound so that when a current of given polarity circulates within coils 21a and 21b, the magnetic fields produced within coils 21a and 21b will have an opposed radial orientation when viewed relative to the rotor 32. In other words, while the magnetic dipoles creates by coils 21a and 21b are aligned in the same direction in space, they exert similar forces on the rotor 32 as the coils 21a and 21b are on opposite sides of the stator 30.

It should be noted that while coil equivalents 21, 22 and 23 are on the same physical pair of poles 41 and 44 in the stator 30, they will not all be in phase during operation of the electric motor 10. Indeed, the three edges are operated typically 120 degrees out of phase relative to each other. Also, the three branches are operated also 120 degrees out of phase relative to each other. However, the wye and edges are not in phase, but instead 30 degrees out of phase relative to each other.

Referring to FIG. 4, the electric motor 10 is controlled by a controller 48. The controller 48 is operatively connected to switches Q1 to Q18, represented collectively by the reference numeral 50 in FIG. 4, to selectively open and close selected ones of the switches Q1 to Q18 at different stages of operation of the motor 10. The controller 48 is for example a microcontroller. The electric motor 10 is also typically provided with a position sensor 52 for sensing a position of the rotor 32 relative to the stator 30 and feeding this information to the controller 48 to time the powering and shutting down the coils 21a to 29b. In some embodiments, the position sensor 52 is also used to sense a rotation speed of the rotor 32 relative to the stator 30. However, in alternative embodiments, the rotation speed is detected using a dedicated speed sensor 54.

The controller 48 includes a processor 56 and memory 58 (e.g., random-access memory, read-only memory, flash memory). The controller 48 may also include in some embodiments an electronic storage unit 60 (e.g., hard disk or solid state drive, among others) and communication interface 62 (e.g., network adapter) for communicating with one or more other systems. The communication interface 62 is also operable to obtain data from the position and speed sensors 52 and 54 and to close and open the switches 50. In some embodiments, the controller 48 also includes peripheral devices, such as cache, other memory, data storage and/or electronic display adapters, among others.

The memory 58, storage unit 60, interface 62 and peripheral devices, when present, are in communication with the processor 56 through a communication bus (solid lines). The storage unit 60 can be a data storage unit (or data repository) for storing data and/or programs. The controller 48 can in some embodiments be operatively coupled to a computer network (“network”) (not shown in the drawings) with the aid of the communication interface 62. The network can be the Internet, an internet and/or extranet, or an intranet and/or extranet that is in communication with the Internet. In some embodiments, the network is part of a network interconnecting components in a vehicle, such as an automobile network, for example selected from a Controller Area Network (CAN), Automotive Ethernet (AE) or FlexRay.

The processor 56 can execute a sequence of machine-readable instructions, which can be embodied in a program or software. The instructions may be stored in a memory location, such as the memory 58. The instructions can be directed to the processor 56, which can subsequently program or otherwise configure the processor 56 to implement methods of operating the electric motor 10 the present disclosure. Examples of operations performed by the processor 56 can include fetch, decode, execute, and writeback. The processor 56 can be part of a circuit, such as an integrated circuit.

Control of the motor 10 is effected through executable code stored on an electronic storage location of the controller 48, such as, for example, in the memory 58 or electronic storage unit 60. The machine executable or machine readable code can be provided in the form of software. During use, the code can be executed by the processor 56. In some cases, the code can be retrieved from the storage unit 60 and stored on the memory 58 for ready access by the processor 56. In some situations, the electronic storage unit 60 can be precluded, and machine-executable instructions are stored in memory 58.

The code can be pre-compiled, or can be compiled during runtime. The code can be supplied in a programming language that can be selected to enable the code to execute in a pre-compiled or as-compiled fashion. The code may provide a user interface allowing commands to be entered, and a control module controlling the dedicated interface, for example in the form of a device driver.

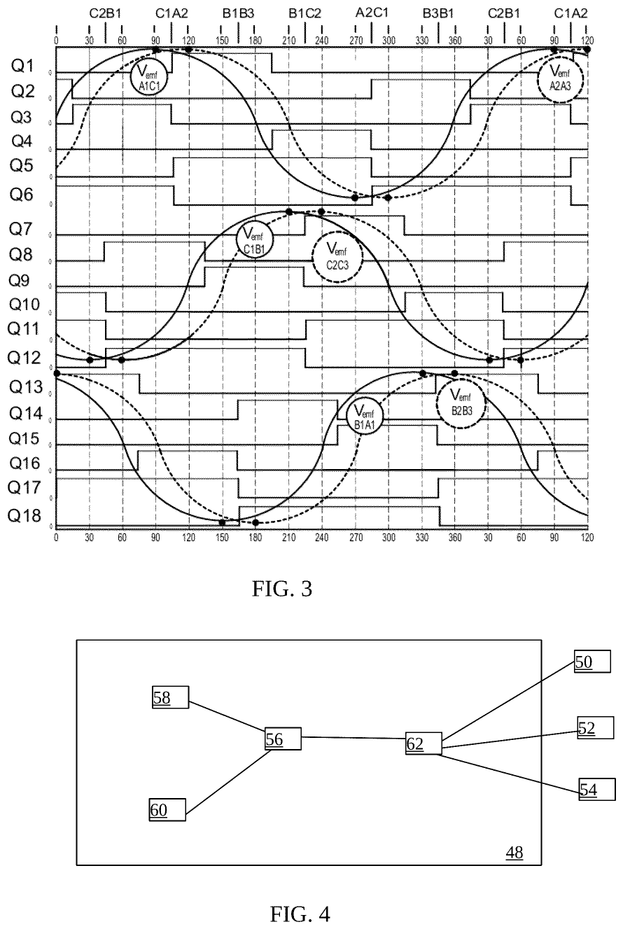

Operation of the motor 10 is now described with respect to FIG. 3. The state of each power module 12a, 12b and 12c changes 4 times during a full rotation of the motor 10, every 90 degrees. In some embodiments, the recovery and/or power phases may be shorter than 90 degrees, and followed by a passive phase in which there is no energy transfer between the power module 12a, 12b or 12c and the motor module 14. This can be created by opening all the switches Q1 to Q18 of the respective power module 12a, 12b or 12c.

More details are now given regarding the operation of one power/recovery cycle of the power module 12a, with the understanding that operation of the power modules 12b and 12c is similar to that of the power module 12a, and the other power/recovery cycle of the power module 12a also operates in a similar manner. In the powered phase of the power module 12a, the application of a voltage across the coil equivalent 21, 22, 23 and 27 is performed using the battery CELL1, using one of the capacitors C10 or C20, or using a combination of the battery CELL1 and one of the capacitors C10 or C20. The powered, recovery and, if present, passive phases correspond respectively to powered, recovery and passive modes of operation of the coils 21a, 21b, 22a, 22b, 23a, 23b, 27a and 27b.

In the embodiment described in the present document, in the powered phase, the capacitor C10 or C20 connected to the motor module 14 is in parallel with the battery CELL1, as the diodes D1 and D2 then only allow current to flow out of the battery CELL1, with negligible resistance, corresponding to a parallel powering of the coils 21a, 21b, 22a, 22b, 23a, 23b, 27a and 27b. Also, the capacitors C10 and C20 connected to coils 21a, 21b, 22a, 22b, 23a, 23b, 27a and 27b in immediate successive powered and recovery phases alternate, and polarity is reversed at the next pair of powered and recovery phase.

During the powered phase, the voltage applied to the coils 21a, 21b, 22a, 22b, 23a, 23b, 27a and 27b is a pulse of DC voltage, which may vary in time according to an exponential decay when the capacitors C10 and C20 are discharged in the coil equivalents 21, 22, 23 and 27. This application of voltage will create an increasing magnetic field in the coils 21a, 21b, 22a, 22b, 23a, 23b, 27a and 27b. In some embodiments, during this powered phase, power is not necessarily delivered for the whole duration of the 90 degrees of rotation of the rotor 32, as the duration of such power delivery can be modulated. Longer application of voltage result in larger magnetic fields, and therefore larger torques at the rotor 32. Therefore, changing the fraction of this phase during which voltage is actually applied can be used to regulate the torque exerted by the motor 10.

During the recovery phase, the battery CELL1 and the capacitors C10 and C20 don't provide power to the coils 21a, 21b, 22a, 22b, 23a, 23b, 27a and 27b. Instead, the polarity of the connection between the coils 21a, 21b, 22a, 22b, 23a, 23b, 27a and 27b and the power terminals T1 and T2 is reversed, when compared to the previous recovery phase, and the energy stored in the magnetic field of the coils 21a, 21b, 22a, 22b, 23a, 23b, 27a and 27b is fed to one of capacitors C10 or C20. The other capacitor C10 or C20, which remains in parallel with respectively the battery CELL1, is used as a potential pump, with the two capacitors C10 and C20 having their anodes connected to each other, with one of the diodes D3 or D4 therebetween, which assists in transferring the energy stored in the coil's magnetic field to the capacitor C10 or C20.

FIG. 3 is a timing diagram illustrating the state of each switch Q1 to Q18 during operation of the motor 10. This timing diagram is periodic with each rotation of the motor. A high state denotes a closed switch Q1 to Q18, allowing electrical connection thereacross. A low state denotes an open switch Q1 to Q18 in which no current flows through the switch Q1 to Q18. The undulating sinusoidal continuous and dashed lines illustrate the electromotive force (EMF) present across the edges (dashed line) and the wye configuration (continuous line) for each of the three phases. The total electromotive force across a whole phase will be the sum of these two curves. The phase for which the power phase starts at each angular position is denoted at the top of the diagram, and the horizontal axis corresponds to the angular position of the rotor with respect to an origin. Typically, the rotor 32 lags slightly relative to the position of a coil 21a to 29a when the latter reaches its peak phase voltage. This offset improves motor efficiency, and is calculated by the controller 100. Theoretical calculations or empirical results may be used to get the correct offset, which, in some embodiments, may vary according to the load applied to the motor 10 and rotation speed of the rotor 32. During each phase, two of the branches and one of the edge are powered. In FIG. 3, the duration of each powered and recovery phase is illustrated as taking a full 90 degrees of rotation of the motor module 14, but these powered and recovery phases can be shortened in some embodiments.

One again, the following text concentrates on operation of the power module 12a, and therefore to operation of the switches Q1 to Q6, with the understanding that the power modules 12b and 12c operate in a similar manner, with a 120 degrees phase difference relative thereto. Switches Q1, Q2, Q5 and Q6 are used in the powered phases. Switches Q3 to Q6 are used in the recovery phase. More specifically, switches Q1 and Q2 are involved in the positive excitation of the coil equivalents 21, 22, 23 and 27 transferring energy from the battery CELL1 and/or the capacitors C10 or C20 towards the coil equivalents 21, 22, 23 and 27, in phase A2C1 (or A2A3-A1C1) of operation of the motor module 14, or in the inverse phase C1A2 (or C1A1-A3A2). These switches Q1 and Q2 are therefore dedicated to powering the coil equivalents 21, 22, 23 and 27 twice for each rotation of the motor module 14. Switches Q5 and Q6 are used to switch between the two excitation polarities. Switches Q3 and Q4 are used during the recovery phase in which energy is recovered in capacitors C10 and C20 via diodes D3 and D4. Switch Q3 is closed when recovering energy from the A2C1 phase in capacitor C10, while switch Q4 is closed when recovering energy from the C1A2 phase in capacitor C20. In the recovery phase, diodes D3 and D4 are used to stop energy transfer when the magnetic circuit coils 21a, 21b, 22a, 22b, 23a, 23b, 27a and 27b are empty, and also prevents the charge of C10 from balancing in C20 and vice versa. At all times, diodes D1 and D2 prevent capacitors C10 and C20 from draining into the battery CELL1. Table 2 includes the sequence of operation of the switches Q1 to Q6 in a different form.

An example of one powered/recovery cycle is now described, for power module 12a, with the understanding that the other corresponding cycles are similar and follow the sequence of FIG. 3 and Table 2. In this example, one of the powered phase and recovery phase of coil equivalents 21, 22, 23 and 27 is described for one turn of rotation.

This cycle starts just before phase C1A2 is activated, at 105 degrees in FIG. 3. When this powered phase starts, coil equivalents 27, 21, 23 and 22 are put in series and a current is fed to these coil equivalents 27, 21, 23 and 22. To that effect, switches Q1 and Q5 are closed so that energy can be provided by the battery CELL1 and/or the capacitor C10. This current is enhanced by any remaining EMF between nodes C1 and A1 and between nodes A3 and A2, due to previous operation cycles. This powered phase is followed by a recovery phase, to recover the magnetic energy remaining in the coil equivalents 27, 21, 23 and 22 in the other capacitor C20. To that effect, switch Q1 is opened and switch Q4 is closed, and switch Q5 remains closed, at about 195 degrees in FIG. 3. In this phase, the EMF generated by the magnetic circuit between nodes C1 and A2 charges capacitor C20 through diode D4, assisted by the tension in capacitor C10 in parallel with the battery CELL1. The recovery phase also creates a torque in the rotor 32. Once the recovery phase is completed, switches Q4 and Q5 are opened, and switches Q2 and Q6 are closed, and the A2 C1 phase of motor module 14 is powered, with an inverse polarity compared to the above-described C1 A2 phase, and the cycle continues. The other two power modules 12b and 12c operate in a similar manner, but offset+/−120 degrees relative to the power module 12a. One notes that this implies that some power and recovery phases pertaining to different ones of the power modules 12a, 12b and 12c overlap, which can further enhance the torque created by motor module 14

One can therefore see that for each phase, there is overlap between the powered mode of each phase and the recovery mode of the other two phases, and overlap between the recovery mode of each phase and the powered mode of the other two phases. This is caused by the fact that some the branches of the wye configuration are shared between the different phases of the electric motor. Each physical coil 21a, 21b, 24a, 24b, 27a and 27b is shared between two of the phases of the motor 14, while each edge is used in a single one of these phases. This coil sharing facilitates creation of a current in the coils 21a to 29b involved in the powered phase due to the EMF created in the branch that is simultaneously active in a recovery phase of another one of the phases.

The power modules 12a, 12b and 12c each cause two power modes per rotation of the rotor 32, which therefore results in a total of 6 powered modes across the whole electrical motor 10 over each rotation. Each powered mode of each power module 12a, 12b and 12c overlaps with two recovery modes in the other ones of the power modules 12a, 12b and 12c. Similarly, each recovery mode of each power module 12a, 12b and 12c overlaps with two powered modes in in the other ones of the power modules 12a, 12b and 12c. This creates several pulse overlaps per revolution of the motor, which contributed to effective power transfer in the motor 10.

The proposed motor 10 can also recover energy when a vehicle stops or goes downhill. The proposed architecture can be used in any application in which coils are alternatively powered and unpowered, For example, three triphasic transformers can be connected to form the circuit of FIG. 1, and these transformers can then be used to provide triphasic current from the power module 12. Indeed, the circuit of FIG. 1 is agnostic regarding the exact device that is connected to the power module 12, as long as this device includes inductances configured as in the motor module 14. It should be noted that starting from a standstill requires a different sequence of operation, similarly to other types of electric motors. The motor 10 will typically need to spin a few turns for the controller before the controller can use the sequence of actions illustrated in FIG. 3.

TABLE 2
Sequence of operation of the motor 10 showing the various phases of
operation, each lasting over 15 degrees of rotation of the stator.

| Position (°) | Q1 | Q2 | Q3 | Q4 | Q5 | Q6 |
|---|---|---|---|---|---|---|
| 0-15 (P) | O | C | O | O | O | C |
| 15-30 (R) | O | O | C | O | O | C |
| 30-45 (R) | O | O | C | O | O | C |
| 45-60 (R) | O | O | C | O | O | C |
| 60-75 (R) | O | O | C | O | O | C |
| 75-90 (R) | O | O | C | O | O | C |
| 90-105(R) | O | O | C | O | O | C |
| 105-120 (P) | C | O | O | O | C | O |
| 120-135 (P) | C | O | O | O | C | O |
| 135-150 (P) | C | O | O | O | C | O |
| 150-165 (P) | C | O | O | O | C | O |
| 165-180 (P) | C | O | O | O | C | O |
| 180-195 (P) | C | O | O | O | C | O |
| 195-210 (R) | O | O | O | C | C | O |
| 210-225 (R) | O | O | O | C | C | O |
| 225-240 (R) | O | O | O | C | C | O |
| 240-255 (R) | O | O | O | C | C | O |
| 255-270 (R) | O | O | O | C | C | O |
| 270-285(R) | O | O | O | C | C | O |
| 285-300 (P) | O | C | O | O | O | C |
| 300-315 (P) | O | C | O | O | O | C |
| 315-330 (P) | O | C | O | O | O | C |
| 330-345 (P) | O | C | O | O | O | C |
| 345-360 (P) | O | C | O | O | O | C |

P: Powered mode.
R: recovery mode.
O: Open switch.
C: Closed switch

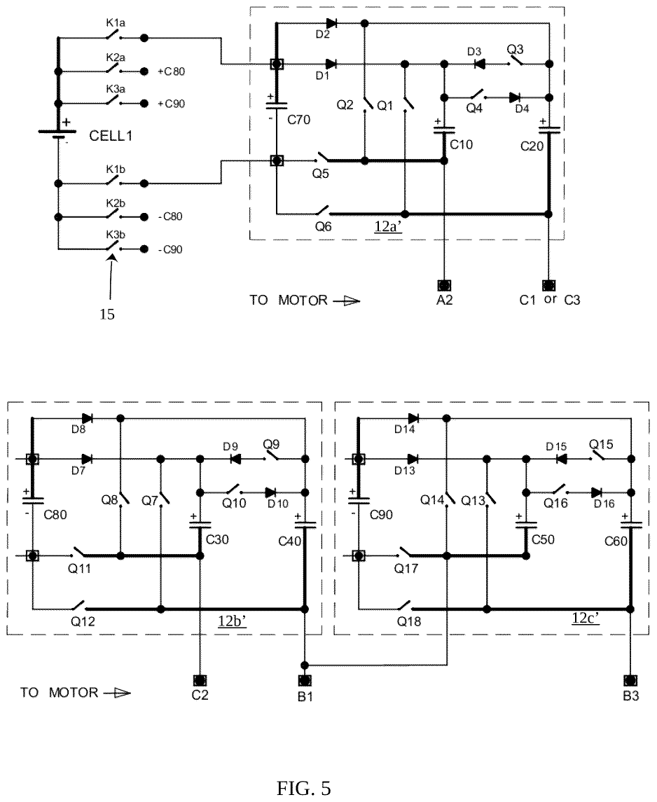

With reference to FIG. 5, in alternative embodiments, a single battery CELL1 is usable to provide power to the three power modules 12a′, 12b′ and 12c′. These power modules 12a′, 12b′ and 12c′ are similar to the three power modules 12a, 12b and 12c described above, except that the batteries CELL1, CELL2 and CELL3 are replaced by a respective capacitor C70, C80 and C90. The battery CELL1 of FIG. 5 is used to charge the capacitors C70, C80 and C90, so that the latter have a function similar to the batteries CELL1, CELL2 and CELL3 in the power modules 12a, 12b and 12c. To that effect, a switching circuit 15 is inserted between the battery CELL1 and the power modules 12a′, 12b′ and 12c′. The switching circuit 15 is used to selectively connect in parallel the battery CELL1 and a single selected one of the capacitors C70, C80 or C90.

More specifically, switches K1a and K1b connect the battery CELL1 in parallel with the capacitor C70 when closed, switches K2a and K2b connect the battery CELL1 in parallel with the capacitor C80 when closed, and switches K3a and K3b connect the battery CELL1 in parallel with the capacitor C90 when closed. For example, each capacitor C70, C80 or C90 is in parallel with the battery CELL1 individually every 60 degrees of rotation during part of the powered phase of the associated power module 12a′, 12b′ or 12c′.

The above description presumed that the motor module 14 was bipolar. However, similar motor modules 14 working on similar principles are possible in alternative embodiments.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. An electric motor, comprising:
a rotor including a permanent magnet;
a stator including coils disposed circumferentially therearound and operable in three phases;
three power modules each operable for powering a respective phase selected from the three phases each power module including
a pair of power input terminals for receiving direct current (DC) electrical power;
a capacitor; and
a plurality of switches selectively openable and closable so that the coils from the respective phase are each operable between a powered mode and a recovery mode, wherein, in the powered mode, the coils from the respective phase are electrically coupled to the power input terminals, the capacitor, or both the power input terminals and the capacitor to allow transfer of electric power from at least one of the power input terminals and the capacitor to the coils of the respective phase, and, in the recovery mode, the coils of the respective phase are electrically coupled to the capacitor to allow transfer of energy stored in the coils of the respective phase to the capacitor;
wherein in operation, each of the three phases are operated alternatively between the powered mode and the recovery mode with an offset of 120 degrees between the phases.

2. The electric motor as defined in claim 1, wherein, in the powered mode, the coils of the respective phase are electrically coupled to both the power input terminals and the capacitor in parallel.

3. The electric motor as defined in claim 2, wherein each power module further comprises a diode for preventing discharge of the capacitor towards the power input terminals.

4. The electric motor as defined in claim 1, wherein
for each of the power modules, the pair of power input terminals is a first pair of power input terminals, the capacitor is a first capacitor, the powered mode is a first powered mode, and the recovery mode is a first recovery mode, the electric motor further comprising a second capacitor;
the plurality of switches are selectively openable and closable so that the coils from the respective phase is operable between a second powered mode and a second recovery mode, wherein, in the second powered mode, the coils from the respective phase are electrically coupled to the power input terminal, the second capacitor, or both the power input terminal and the second capacitor to allow transfer of energy from at least one of the power input terminal and the second capacitor to the coil, and, in the second recovery mode, the coils from the respective phase are electrically coupled to the second capacitor to allow transfer of energy stored in the coils from the respective phase to the second capacitor;
the first and second power modes operating the coils from the respective phase with inverse polarities relative to each other

5. The electric motor as defined in claim 4, wherein in the first and second recovery modes, the first and second capacitors and the coils from the respective phase are all in series with the first and second capacitors having anodes thereof connected to each other through a diode.

6. The electric motor as defined in claim 5, wherein in the first and second recovery modes, transfer of energy from the coil to one of the first and second capacitors is facilitated by the other one of the first and second capacitors due to the voltage of the first and second capacitors being in series with the coil with inverted polarities.

7. The electric motor as defined in claim 1, wherein
the rotor defines a north pole and a south pole;
each of the coils from the respective phase are electrically connected in series to another one of the coils from the respective phase located diametrically opposed thereto on the stator and wound such that forces exerted on the north and south poles by the two coils are similar to each other.

8. The electric motor as defined in claim 1, wherein the coils include wye coils connected to each other in a wye configuration defining three branches each defining opposed proximal and distal ends, the proximal ends being substantially equipotentially electrically linked to each other, the remaining coils being distributed among three edges each defining edge first and second ends, two of the edge second ends and one of the distal ends being substantially equipotentially electrically linked to each other, and the remaining edge being substantially equipotentially electrically linked to an other one of the distal ends, wherein each of the three phases includes a respective pair of the branches and a respective one of the edges.

9. The electric motor as defined in claim 8, wherein the edges have substantially similar edge inductances, and the branches have substantially similar branch inductances.

10. The electric motor as defined in claim 9, wherein the edge inductances are about twice the branch inductances.

11. The electric motor as defined in claim 8, wherein within each phase, the wye coils and the edge coils are electrically offset by about 30 degrees.

12. The electric motor as defined in claim 11, wherein the coils within each side are angularly superposed with the coils of a respective one of the branches.

13. The electric motor as defined in claim 1, further comprising a position sensor for sensing a relative position between the rotor and the stator.

14. The electric motor as defined in claim 1, further comprising a speed sensor for sensing a relative rotation speed between the rotor and the stator.

15. The electric motor as defined in claim 1, wherein the motor is operable to exert a braking action to recover mechanical energy from a moving mass connected to the motor by slowing down the moving mass and transferring energy to the power terminals.

16. The electric motor as defined in claim 1, wherein the switches from the plurality of switches are electronic switches, the electric motor further comprising a controller for selectively individually opening and closing the electronic switches.

17. The electric motor as defined in claim 1, further comprising a switching circuit for selectively connecting a single DC power source to the first and second power input terminals of a selected one of the power control module.

18. The electric motor as defined in claim 1, further comprising diodes for preventing transfer of power from the capacitor towards the battery, whereby the energy recovered during operation in a recovery mode and stored in the capacitor is used to at least partially power a following powered mode.

19. The electric motor as defined in claim 1, wherein the powered mode in each one the three phases overlaps with the recovery mode of the other two phases and the recovery mode in each one the three phases overlaps with the powered mode of the other two phases.

20. The electric motor as defined in claim 19, wherein each phase in the powered mode includes at least one shared coil, the shared coil being part of another one of the phases operated in the recovery mode, the shared coil being configured such that the electromotive force (EMF) created by the recovery mode and the tension created by the powered mode have a same polarity.

21. The electric motor as defined in claim 8, wherein in each one of the phases, a respective one of the edge is connected in series with a respective pair of the branches.
